(19) United States
(12) Patent Application Publication
(10) Pub. No.: US 2025/0291539 A1
(43) Pub. Date: Sep. 18, 2025

(54) IMAGE MIRRORING SYSTEM AND METHOD

(71) Applicant: Samsung Electronics Co., Ltd., Suwon-si (KR)

(72) Inventors: Sungchang JANG, Suwon-si (KR); Yongwoo SHIN, Suwon-si (KR); Junhae CHOI, Suwon-si (KR)

(21) Appl. No.: 19/223,866

(22) Filed: May 30, 2025

Related U.S. Application Data
(63) Continuation of application No. PCT/KR2023/019669, filed on Dec. 1, 2023.

(30) Foreign Application Priority Data
Dec. 27, 2022 (KR) 10-2022-0185377

(51) Int. Cl. G06F 3/14

(52) U.S. Cl. CPC G06F 3/1454

(57) ABSTRACT

An image mirroring system may comprise: a first display device configured to receive image data, and display a first image on the basis of the image data; and a second display device configured to receive mirroring image data from the first display device, and display a second image based on the mirroring image data. The first display device may sense the second display device capable of performing data communication, determine a mirroring area in the first image, generate the mirroring image data based on the mirroring area, and output the mirroring image data onto the second display device.

### CROSS-REFERENCE TO RELATED APPLICATIONS

This application is a continuation of International Application No. PCT/KR2023/019669 designating the United States, filed on Dec. 1, 2023, in the Korean Intellectual Property Receiving Office and claiming priority to Korean Patent Application No. 10-2022-0185377, filed on Dec. 27, 2022, in the Korean Intellectual Property Office, the disclosures of each of which are incorporate by reference herein in their entireties.

### BACKGROUND

### Field

The disclosure relates to an image mirroring system and method for determining a mirroring area and a mirroring layout based on specifications of an image and a display device.

### Description of Related Art

Recently, there is increasing interest in using digital multimedia services, such as videos and games using electronic devices. However, the fixed screen size of electronic devices imposes limitations on the efficient display of diverse digital multimedia contents. Accordingly, screen sharing technology (e.g., mirroring technology) is being utilized to display the screen displayed on the electronic device on an external device through the wired/wireless communication function of the electronic device.

Screen sharing technology may refer to a technology that enables the sharing of screen data between multiple electronic devices with displays. The image displayed on the display of the electronic device is transmitted to an external device using a peer-to-peer (P2P) scheme using short-range wireless communication, such as wireless fidelity (Wi-Fi), and the external device may display the received image together with the electronic device.

Conventional screen sharing technology duplicates the entire display screen and displays it on an external device, which reduces the usability of digital multimedia data. Conventional screen sharing technology enables control of an image only on the device transmitting the screen data, but not on the external device receiving the screen data, which results in reduction of the usability of screen sharing.

### SUMMARY

Embodiments of the disclosure may provide an image mirroring system and method that determines an area with high importance in an image of a source device as a mirroring area, displays a mirroring image corresponding to the mirroring area on a sink device, and controls the layout of the mirroring image on the sink device.

A display device according to an example embodiment of the disclosure may comprise: memory storing at least one instruction, a display, and at least one processor, comprising processing circuitry, electrically connected to the memory and individually and/or collectively, configured to execute the at least one instruction, and cause the display device to: detect at least one external display device capable of data communication; determine a mirroring area in a first image displayed via the display; generate mirroring image data based on the mirroring area; and output at least one of the mirroring image data to the external display device.

In an example embodiment, based on detecting the external display device, at least one processor, individually and/or collectively, may be configured to cause the display device to receive from the external display device a display device specification including at least one of a device type, resolution, whether multi-view is supported, a display mode, and a current display image.

In an example embodiment, based on determining the mirroring area, at least one processor, individually and/or collectively, may be configured to cause the display device to: extract at least one partial area formed independently from a surrounding image in the first image; and determine the partial area as at least one mirroring area, based on any one of an automatic setting mode and a user setting mode.

In an example embodiment, in the automatic setting mode, at least one processor, individually and/or collectively, may be configured to cause the display device to: determine the partial area displayable on the external display device among at least one partial area, based on the display device specification; and determine the partial area having a highest specification suitability with the display device specification among the at least one partial area as at least one mirroring area.

In an example embodiment, in the user setting mode, at least one processor, individually and/or collectively, may be configured to cause the display device to: provide a selection option for at least one partial area by emphasizing and displaying an edge of the at least one partial area; and determine at least one mirroring area from among the at least one partial area, based on the selection of the selection option by a user.

In an example embodiment, in an auto tracing mode, at least one processor, individually and/or collectively, may be configured to cause the display device to: detect a moving object moving in the first image; extract a moving object area including the moving object; and determine the moving object area as at least one mirroring area, based on at least one of an automatic setting mode and a user setting mode.

A display device according to an example embodiment of the disclosure may comprise: memory storing at least one instruction, a display, and at least one processor, comprising processing circuitry, electrically connected to the memory and configured to execute the at least one instruction and to cause the display device to: receive mirroring image data from at least one external display device; set a mirroring layout based on the mirroring image data and a display device specification; generate second image data based on the mirroring layout; and display via the display a second image based on the second image data.

In an example embodiment, based on setting the mirroring layout, at least one processor, individually and/or collectively, may be configured to cause the display device to: set a screen layout including at least one of a display mode of the second image and a second image count; set a frame layout including at least one of a size of the second image, a position of the second image, and a frame shape of the second image; and set a content layout including at least one of a zoom-in of the second image, a zoom-out of the second image, and a center shift of the second image.

In an example embodiment, at least one processor, individually and/or collectively, may be configured to cause the display device to automatically set at least one of the screen layout, the frame layout, and the content layout based on the display device specification.

In an example embodiment, at least one processor, individually and/or collectively, may be configured to cause the display device to set at least one of the screen layout, the frame layout, and the content layout based on user input.

An image mirroring method according to an example embodiment of the disclosure may comprise: receiving image data, displaying a first image based on the image data, detecting at least one external display device capable of data communication, determining a mirroring area in the first image, generating mirroring image data based on the mirroring area, and outputting the mirroring image data to the at least one of external display device.

In an example embodiment, the detecting the external display device may include receiving from the external display device a display device specification including at least one of a device type, resolution, whether multi-view is supported, a display mode, and a current display image.

In an example embodiment, the determining the mirroring area may include extracting at least one partial area formed independently from a surrounding image in the first image, and determine the partial area as at least one mirroring area based on any one of an automatic setting mode and a user setting mode.

In an example embodiment, in the automatic setting mode, the determining the mirroring area may include: determining the partial area displayable on the external display device among at least one partial area based on the display device specification, and determining the partial area having a highest specification suitability with the display device specification among the at least one partial area as at least one mirroring area.

In an example embodiment, in the user setting mode, the determining the mirroring area may comprise: providing a selection option for at least one partial area by emphasizing and displaying an edge of the at least one partial area, and determining at least one mirroring area from among the at least one partial area based on the selection of the selection option by a user.

In an example embodiment, in an auto tracing mode, determining the mirroring area may include detecting a moving object moving in the first image, extract a moving object area including the moving object, and determining the moving object area as at least one mirroring area based on at least one of an automatic setting mode and a user setting mode.

An image mirroring method according to an example embodiment of the disclosure may comprise: receiving mirroring image data from at least one external display device, setting a mirroring layout based on the mirroring image data and a display device specification, generating second image data based on the mirroring layout, and displaying a second image based on the second image data.

In an example embodiment, setting the mirroring layout may include: setting a screen layout including at least one of a display mode of the second image and a second image count, setting a frame layout including at least one of a size of the second image, a position of the second image, and a frame shape of the second image, and setting a content layout including at least one of a zoom-in of the second image, a zoom-out of the second image, and a center shift of the second image.

An image mirroring system according to an example embodiment of the disclosure may comprise: a first display device configured to receive image data and display a first image based on the image data, and a second display device configured to receive mirroring image data from the first display device and display a second image based on the mirroring image data. The first display device may detect the second display device capable of data communication. The first display device may determine a mirroring area in the first image. The first display device may generate mirroring image data based on the mirroring area. The first display device may output the mirroring image data to the second display device.

In an example embodiment, the second display device may set a mirroring layout based on the mirroring image data and a display device specification. The second display device may generate second image data based on the mirroring layout. The second display device may display the second image based on the second image data.

According to various example embodiments of the disclosure, the image mirroring system and method of the disclosure may extract a partial area in a first image of a source device and determine among the partial area a mirroring area to be mirrored, thereby selectively providing the mirroring image to a sink device.

According to various example embodiments of the disclosure, the image mirroring system and method of the disclosure may directly change the mirroring layout of the mirrored second image on the sink device, thereby freely controlling the mirroring layout.

Therefore, the image mirroring system and method of the disclosure may increase the usability and utilization of image mirroring technology.

Effects achievable by the disclosure are not limited to the above-mentioned effects, but other effects not mentioned may be apparently derived and understood by one of ordinary skill in the art to which example embodiments of the disclosure pertain, from the following description. In other words, unintended effects in practicing various embodiments of the disclosure may also be derived by one of ordinary skill in the art from example embodiments of the disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example image mirroring system according to various embodiments;

FIG. 2 is a block diagram illustrating an example configuration of a display device according to various embodiments;

FIG. 3 is a flowchart illustrating an example operation of a first display device according to various embodiments;

FIGS. 4A, 4B and 4C are diagrams illustrating examples of second display devices according to various embodiments;

FIG. 5 is a diagram illustrating a partial area in a first image according to various embodiments;

FIG. 6 is a diagram illustrating a moving object area in a first image according to various embodiments;

FIGS. 7A and 7B are diagrams illustrating a mirroring area determined in a first display device according to various embodiments;

FIG. 8 is a flowchart illustrating an example operation of a second display device according to various embodiments;

FIG. 9 is a diagram illustrating a screen layout determined in a second display device according to various embodiments;

FIG. 10 is a diagram illustrating a frame layout determined in a second display device according to various embodiments;

FIG. 11 is a diagram illustrating a content layout determined in a second display device according to various embodiments;

FIGS. 12A, 12B and 12C are diagrams illustrating an application of an image mirroring system according to various embodiments; and

FIG. 13 is a flowchart illustrating an example operation of an image mirroring method according to various embodiments.

### DETAILED DESCRIPTION

Hereinafter, various example embodiments of the disclosure are described in greater detail with reference to the drawings. However, the disclosure may be implemented in other various forms and is not limited to the example embodiments set forth herein. The same or similar reference denotations may be used to refer to the same or similar elements throughout the disclosure and the drawings. For clarity and brevity, no description may be made of well-known functions and configurations in the drawings and relevant descriptions.

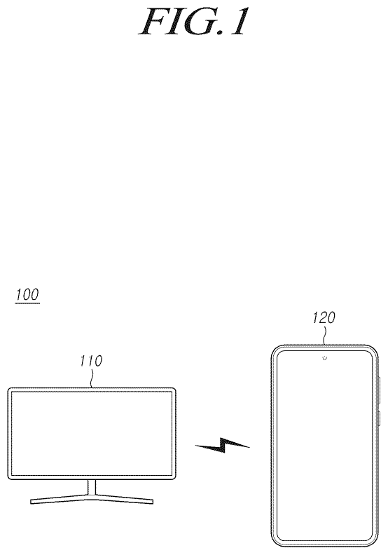

FIG. 1 is a diagram illustrating an example image mirroring system 100 according to various embodiments.

Referring to FIG. 1, the image mirroring system 100 according to various embodiments of the disclosure may include a first display device 110 and a second display device 120.

For example, the image mirroring system 100 of the disclosure may include a first display device 110 that receives image data and displays a first image based on the image data, and a second display device 120 that receives mirroring image data from the first display device 110 and displays a second image based on the mirroring image data.

The image mirroring system 100 of the disclosure may extract a partial area in the first image of the first display device 110 and determine among the partial area a mirroring area to be mirrored, thereby selectively providing the mirroring image to the second display device 120.

The image mirroring system 100 of the disclosure may directly change the mirroring layout of the mirrored second image on the second display device 120, thereby freely controlling the mirroring layout.

According to an example, the first display device 110 may receive image data. The first display device 110 may display the first image based on the image data. The first display device 110 may be a source device. For example, the first display device 110 may mirror the first image to a sink device.

According to an example, the second display device 120 may receive mirroring image data from the first display device 110. The second display device 120 may display the second image based on the mirroring image data. The second display device 120 may be a sink device. For example, the second display device 120 may mirror an image of the source device and display the same as a second image.

Accordingly, the image mirroring system 100 of the disclosure may increase the usability and utilization of the image mirroring technology.

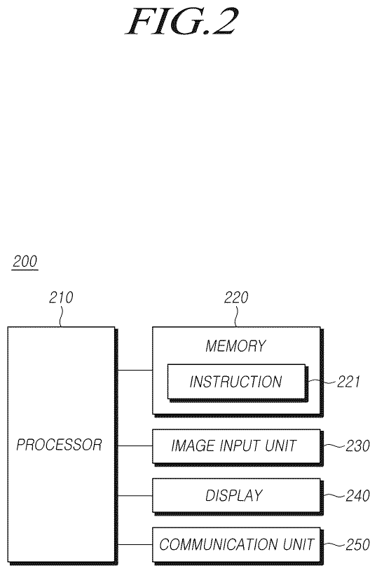

FIG. 2 is a block diagram illustrating an example configuration of a display device 200 according to various embodiments.

The display device 200 of FIG. 2 may be the first display device 110 of FIG. 1. The display device of FIG. 2 may be the second display device 120 of FIG. 1.

The display device 200 may be, but is not limited to, a smartphone, a tablet PC, a PC, a smart TV, a mobile phone, a personal digital assistant (PDA), a laptop computer, a media player, a micro server, a digital broadcast terminal, a navigation, a kiosk, a home appliance, or other mobile or non-mobile computing devices. The display device 200 may be wearable terminals, such as watches and glasses, capable of performing various computing functions, such as real-time video watching, and communication. The display device 200 may be various types of terminals without being limited to the above examples.

According to an example, the memory 220 is a storage medium used by the display device 200 and may store data, such as at least one command 221 or configuration information corresponding to at least one program. The program may include an operating system (OS) program and various application programs.

In an example, the memory 220 may include at least one type of storage medium of flash memory types, hard disk types, multimedia card micro types, card types of memories (e.g., SD or XD memory cards), random access memories (RAMs), static random access memories (SRAMs), read-only memories (ROMs), electrically erasable programmable read-only memories (EEPROMs), programmable read-only memories (PROMs), magnetic memories, magnetic disks, or optical discs.

According to an example, the image input unit 230 may include various circuitry and receive viewing images and viewing image information through a tuner (not shown), an input/output unit (not shown), or the communication unit 250. The image input unit 230 may include at least one of the tuner and the input/output unit (e.g., including circuitry). The tuner may tune and select the frequency of a broadcast channel to be received by the display device 200 among many radio wave components, by amplifying, mixing, and resonating the broadcast signal wiredly/wirelessly received. The broadcast signal may include video, audio, and additional data (e.g., electronic program guide (EPG)). The tuner may receive broadcast channels (or viewing images) from various broadcast sources, such as terrestrial broadcasts, cable broadcasts, satellite broadcasts, Internet broadcasts, and the like. The tuner may be implemented integrally with the display device 200 or may be implemented as a separate tuner electrically connected to the display device 200. The input/output unit may include at least one of a high definition multimedia interface (HDMI) input port, a component input jack, a PC input port, and a USB input jack capable of receiving a viewing image and viewing image information from an external device of the display device 200 under the control of the processor 210. It will be apparent to one of ordinary skill in the art that the input/output unit may be added, deleted, and/or changed according to the performance and structure of the display device 200.

According to an embodiment, the display 240 may perform functions for outputting information in the form of numbers, characters, images, and/or graphics. The display 240 may include at least one hardware module for outputting. The at least one hardware module may include at least one of, e.g., without limitation, a liquid crystal display (LCD), a light emitting diode (LED), a light emitting polymer display (LPD), an organic light emitting diode (OLED), an active matrix organic light emitting diode (AMOLED), a flexible LED (FLED), or the like. The display 240 may display a screen corresponding to data received from the processor 210. The display 240 may be referred to as an ‘output unit’, a ‘display unit’, or by other terms having a technical meaning equivalent thereto.

According to an example, the communication unit 250 may include various communication circuitry and provide a wired/wireless communication interface that enables communication with an external device. The communication unit 250 may include at least one of a wired Ethernet, a wireless LAN communication unit, and a short-range communication unit. The wireless LAN communication unit may include, e.g., Wi-Fi, and may support the wireless LAN standard (IEEE802.11x) of the institute of electrical and electronics engineers (IEEE). The wireless LAN communication unit may be wirelessly connected to an access point (AP) under the control of the processor 210. The short-range communication unit may perform short-range communication wirelessly with an external device under the control of the processor 210. Short-range communication may include bluetooth, bluetooth low energy, infrared data association (IrDA), ultra-wideband (UWB), and near-field communication (NFC). The external device may include a server device and a mobile terminal (e.g., smartphone, tablet, etc.) providing, e.g., a video service.

According to an example, the processor 210 may include various processing circuitry and execute computation or data processing regarding controlling at least one other component of the display device 200 and/or communication by executing at least one command 221 stored in the memory 220. The processor 210 may include at least one of a central processing unit (CPU), a graphic processing unit (GPU), a micro controller unit (MCU), a sensor hub, a supplementary processor, a communication processor, an application processor, an application specific integrated circuit (ASIC), and/or field programmable gate arrays (FPGA) and may have multiple cores. Thus, the processor 210 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an example, the processor 210 may detect at least one ambient sink device capable of data communication. The processor 210 may determine a mirroring area in the screen displayed on the display 240. The processor 210 may generate mirroring image data based on the mirroring area. The processor 210 may output the mirroring image data to at least one sink device.

In an example, the processor 210 may receive mirroring image data from at least one source device. The processor 210 may set a mirroring layout based on the mirroring image data and display device specifications. The processor 210 may display an image on the display 240 based on the mirroring layout.

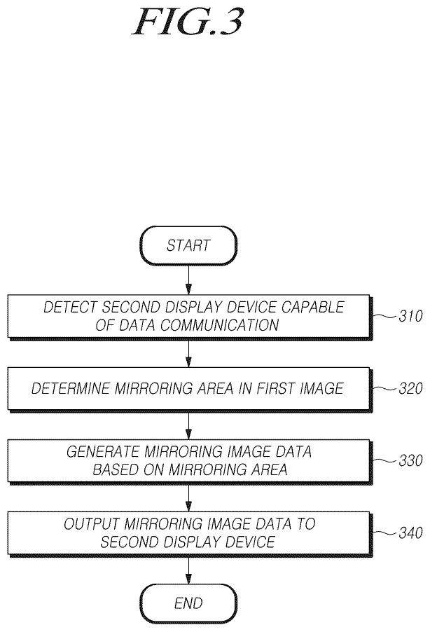

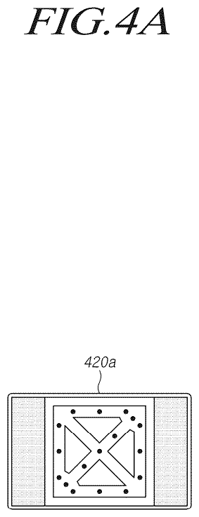

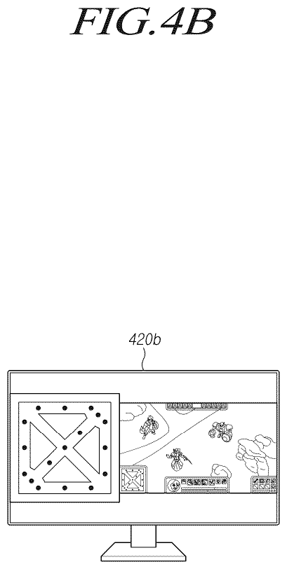

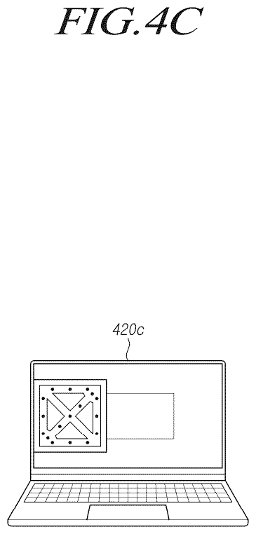

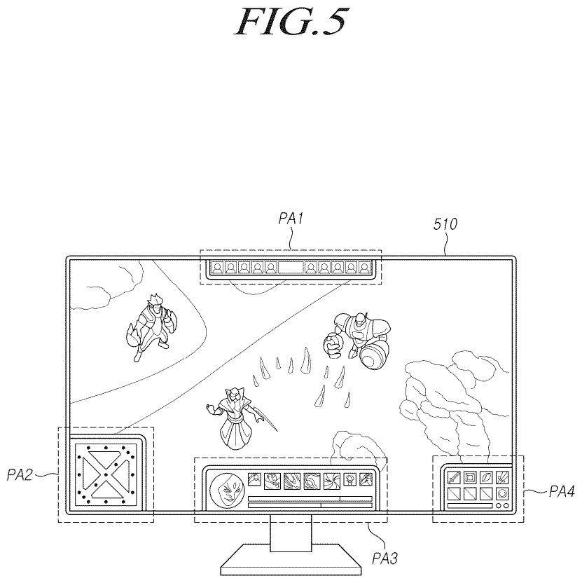

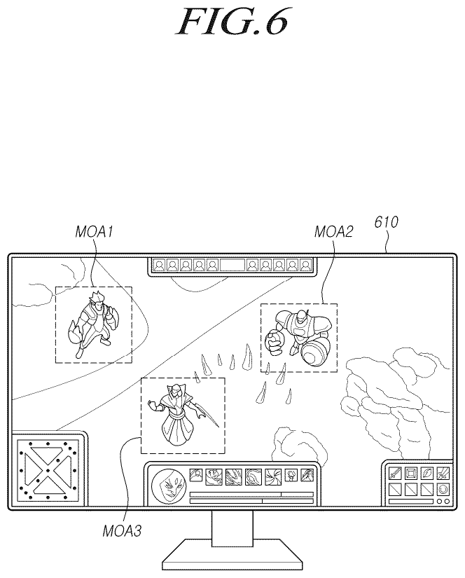

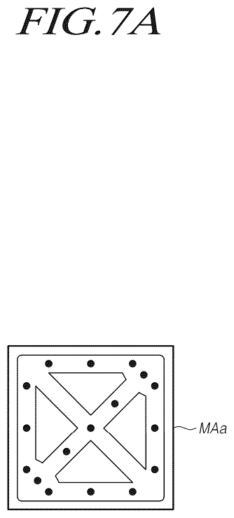

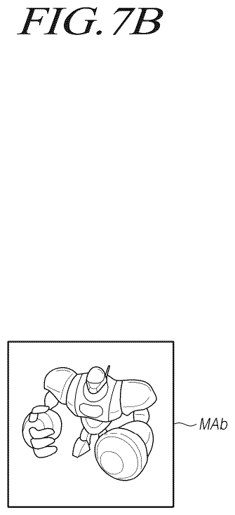

FIG. 3 is a flowchart illustrating example operations of a first display device according to various embodiments. FIGS. 4A, 4B and 4C are diagrams illustrating examples of second display devices according to various embodiments. FIG. 5 is a diagram illustrating a partial area in a first image according to various embodiments. FIG. 6 is a diagram illustrating a moving object area in a first image according to various embodiments. FIGS. 7A and 7B are diagrams illustrating a mirroring area determined in a first display device according to various embodiments.

Referring to FIGS. 3, 4A, 4B, 4C, 5, 6, 7A and 7B (which may be referred to as FIGS. 3 to 7B), the first display device may receive image data and display a first image based on the image data.

As illustrated in FIG. 3, a first display device may detect a second display device capable of data communication (operation 310). The first display device may determine a mirroring area in the first image (operation 320). The first display device may generate the mirroring image data based on the mirroring area (operation 330). The first display device may output the mirroring image data to the second display device (operation 340).

According to an example, in operation 310, the first display device may detect the second display device capable of data communication. For example, the first display device may be a source device that displays the first image based on the image data. For example, the second display device may be a sink device that mirrors the first image and displays a second image.

The first display device may detect the second display device positioned nearby and receive a display device specification from the second display device. For example, when detecting the second display device, the first display device may receive from the second display device the display device specification including at least one of the device type, resolution, whether multi-view is supported, display mode, and current display image.

Referring to FIGS. 4A, 4B and 4C, the second display device may display various types of second images according to the display device specification.

For example, as illustrated in FIG. 4A, the second display device may be a tablet PC. The second display device may display the second image in a full-screen mode. In the full-screen mode, the second display device may display the second image on the entire screen based on the resolution of the second display device.

For example, as illustrated in FIG. 4B, the second display device may be a desktop PC. The second display device may support multi-view. When supporting multi-view, the second display device may receive a plurality of mirroring image data from the first display device and display a plurality of second images respectively corresponding to the plurality of mirroring image data.

For example, as illustrated in FIG. 4C, the second display device may be a notebook PC. The second display device may display the second image in a window mode. In the window mode, the second display device may display the second image on a window screen positioned on a portion of the screen.

According to an example, in operation 320, the first display device may determine a mirroring area in the first image. For example, the first display device may determine important information in the first image and determine an area corresponding to the important information as a mirroring area.

Referring to FIG. 5, when determining the mirroring area, the first display device may extract at least one partial area formed independently of the surrounding image in the first image.

For example, as illustrated in FIG. 5, the first display device 510 may extract a first partial area PA1, a second partial area PA2, a third partial area PA3, and a fourth partial area PA4 independent of the surrounding image in the first image. The partial area may be an area that is fixed at a predetermined position in the first image and does not move.

The first display device 510 may determine the partial area as a mirroring area. For example, the first display device 510 may determine the partial area as at least one mirroring area based on either an automatic setting mode or the user setting mode. The automatic setting mode may be a mode for automatically determining important information in the first image and determining a mirroring area based on the important information. The user setting mode may be a mode for determining a mirroring area in the first image based on the selection of a user.

In the automatic setting mode, the first display device 510 may determine the partial area displayable on the second display device among the at least one partial area based on the display device specification. For example, the first display device 510 may automatically determine whether the partial area is displayable on the second display device based on at least one of the device type, resolution, whether multi-view is supported, display mode, and current display image. The first display device 510 may determine the partial area having the highest specification suitability with the display device among the at least one partial area as at least one mirroring area. For example, the first display device 510 may calculate a specification suitability of the partial area with respect to the display device specification. The specification suitability may be data obtained by quantifying the degree to which the partial area matches the display device specification.

In the user setting mode, the first display device 510 may provide a selection option for at least one partial area by emphasizing and displaying an edge of the at least one partial area. For example, the first display device 510 may provide a selection option selectable by the user for each of the partial areas (e.g., PA1, PA2, PA3, and PA4). For example, the user may select at least one partial area of a selection option using an input device (e.g., a mouse, a remote controller, a touch panel). The first display device 510 may determine at least one partial area as at least one mirroring area based on the selection of the selection option by the user.

Referring to FIG. 6, when the mirroring area is determined, the first display device 610 may provide an auto tracing mode. The auto tracing mode may be a mode where a certain object moving in the first image is targeted and continuously displayed.

In the auto tracing mode, the first display device 610 may detect a moving object moving in the first image. The first display device 610 may extract a moving object area including the moving object.

For example, as illustrated in FIG. 6, the first display device 610 may extract a first moving object area MOA1, a second moving object area MOA2, and a third moving object area MOA3 including the moving object from the first image. For example, the moving object area may be an area that continuously moves in the first image.

The first display device 610 may determine the moving object area as at least one mirroring area, based on at least one of the automatic setting mode and the user setting mode. The automatic setting mode may be a mode for automatically determining important information in the first image and determining a mirroring area based on the important information. The user setting mode may be a mode for determining a mirroring area in the first image based on the selection of a user.

In the automatic setting mode, the first display device 610 may determine a moving object area displayable on the second display device among the at least one moving object area, based on the display device specification. For example, the first display device 610 may automatically determine whether the moving object area is displayable on the second display device, based on at least one of the device type, resolution, whether multi-view is supported, display mode, and current display image. The first display device 610 may determine the moving object area having the highest specification suitability with the display device among the at least one moving object area as at least one mirroring area. For example, the first display device 610 may calculate a specification suitability of the moving object area with respect to the display device specification. The specification suitability may be data obtained by quantifying the degree to which the moving object area matches the display device specification.

In the user setting mode, the first display device 610 may provide a selection option for at least one moving object area by emphasizing and displaying an edge of the at least one moving object area. For example, the first display device 610 may provide a selection option that the user may select for each of the moving object areas (e.g., MOA1, MOA2, and MOA3). For example, the user may select at least one partial area of a selection option using an input device (e.g., a mouse, a remote controller, a touch panel). The first display device 610 may determine at least one moving object area as at least one mirroring area based on the selection of the selection option by the user.

According to an example, in operation 330, the first display device may generate mirroring image data based on the mirroring area. The mirroring image data may be image data corresponding to the mirroring area. For example, as illustrated in FIG. 7A, the mirroring image data may be image data corresponding to the determined mirroring area MAa among the partial areas. For example, as illustrated in FIG. 7B, the mirroring image data may be image data corresponding to the determined mirroring area MAb among the moving object areas.

According to an example, in operation 340, the first display device may output the mirroring image data to the second display device. For example, the first display device may transmit the mirroring image data to the second display device using data communication.

As such, the image mirroring system 100 of the disclosure may extract a partial area in the first image of the first display device and determine a mirroring area among the partial areas, thereby selectively providing the mirroring image to the second display device.

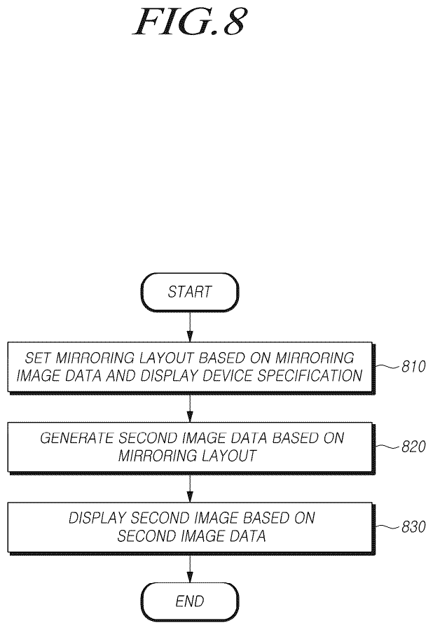

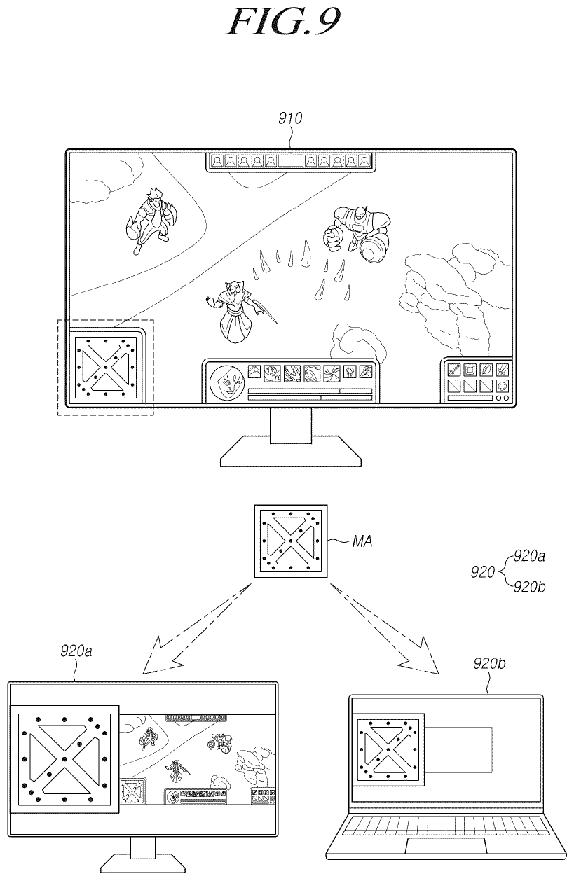

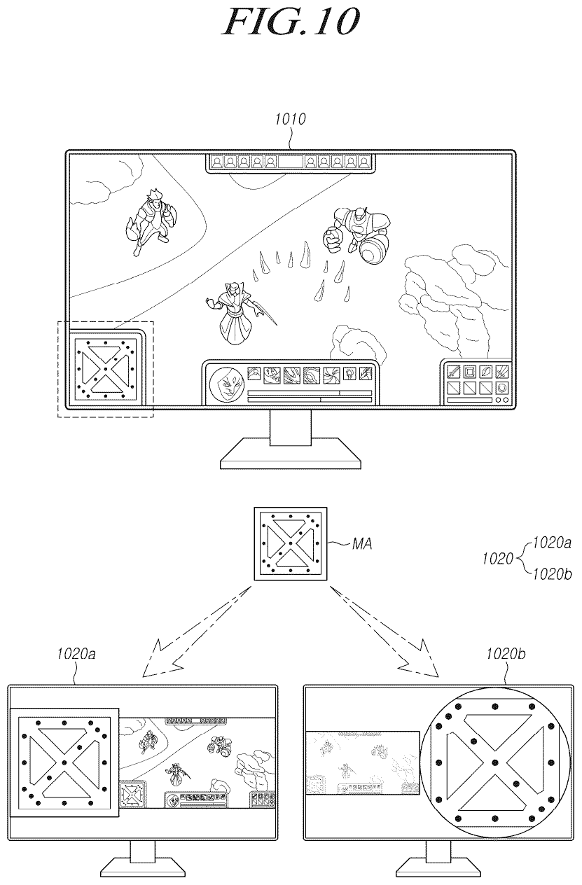

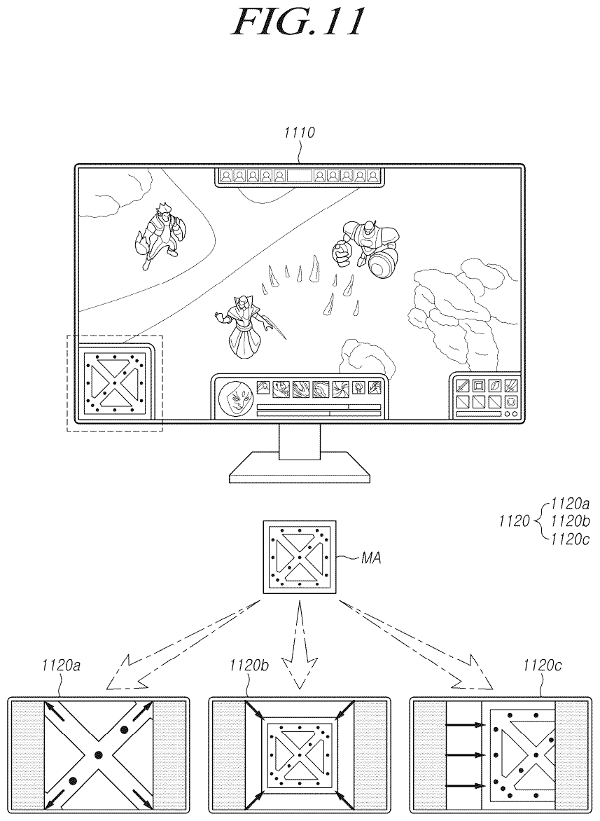

FIG. 8 is a flowchart illustrating example operations of a second display device according to various embodiments. FIG. 9 is a diagram illustrating a screen layout determined in a second display device according to various embodiments. FIG. 10 is a diagram illustrating a frame layout determined in a second display device according to various embodiments. FIG. 11 is a diagram illustrating a content layout determined in a second display device according to various embodiments.

Referring to FIGS. 8, 9, 10 and 11 (which may be referred to as FIGS. 8 to 11), the second display device may receive mirroring image data from the first display device and display a second image based on the mirroring image data.

As illustrated in FIG. 8, the second display device may set a mirroring layout based on the mirroring image data and the display device specification (operation 810). The second display device may generate second image data based on the mirroring layout (operation 820). The second display device may display the second image based on the second image data (operation 830).

According to an example, in operation 810, the second display device may set a mirroring layout based on the mirroring image data and the display device specification. For example, the mirroring layout may include a screen layout, a frame layout, and a content layout.

Referring to FIG. 9, the second display device 920 may receive mirroring image data from the first display device 910 and display a second image based on the mirroring image data. The second display devices 920a and 920b may set a screen layout including at least one of the display mode of the second image and the second image count. For example, the screen layout may include whether the second image is in a full-screen mode and whether the second image is in a window mode. For example, the screen layout may include whether multi-view is executed for the second image and the number of second images.

As illustrated in FIG. 9, the second display device 920 may set a screen layout based on the mirroring image data and the display device specification. For example, the second display device 920a may execute multi-view in the full-screen mode and display two second images based on the mirroring image data. For example, the second display device 920b may display one second image based on the mirroring image data in the window mode.

Referring to FIG. 10, the second display device 1020 may receive mirroring image data from the first display device 1010 and display a second image based on the mirroring image data. The second display devices 1020a and 1020b may set the frame layout including at least one of the size of the second image, the position of the second image, and the frame shape of the second image. For example, the frame layout may include the size at which the second image is displayed and the position at which the second image is displayed. For example, the frame layout may include the shape of the frame displaying the second image.

As illustrated in FIG. 10, the second display device 1020 may set a frame layout based on the mirroring image data and the display device specification. For example, the second display device 1020a may display a second image having a relatively small size on the left side of the screen in a rectangular frame. For example, the second display device 1020b may display a relatively large second image on the right side of the screen in a circular frame.

Referring to FIG. 11, the second display device 1120 may receive mirroring image data from the first display device 1110 and display a second image based on the mirroring image data. The second display devices 1120a, 1120b, and 1120c may set a content layout including at least one of a zoom-in of the second image, a zoom-out of the second image, and a center shift of the second image. For example, the content layout may include whether the mirroring area displayed as the second image is zoomed-in (or enlarged) and whether the mirroring area displayed as the second image is zoomed-out (or shrunken). For example, the content layout may include a shift of the center of the mirroring area displayed as the second image.

As illustrated in FIG. 11, the second display device 1120 may set a screen layout based on the mirroring image data and the display device specification. For example, the second display device 1120a may display the second image where the mirroring area has been zoomed in. For example, the second display device 1120b may display the second image where the mirroring area has been zoomed out. For example, the second display device 1120c may display the second image where the mirroring area has been moved in a first direction (e.g., the right direction).

The second display device may automatically set the mirroring layout based on the display device specification. For example, the second display device may automatically set at least one of the screen layout, the frame layout, and the content layout, based on at least one of device type, resolution, whether multi-view is supported, display mode, and current display image.

The second display device may set the mirroring layout based on the user's input. For example, the second display device may receive a user input to the mirroring layout from the user through an input device (e.g., a mouse, a remote controller, or a touch panel). The second display device may set at least one of the screen layout, the frame layout, and the content layout, based on the user input.

According to an example, in operation 820, the second display device may generate second image data based on the mirroring layout. For example, the second display device may generate second image data corresponding to the set mirroring layout.

According to an example, in operation 830, the second display device may display second image based on the second image data. For example, the second display device may display the second image reflecting the mirroring layout for the mirroring image data received from the first display device.

As such, the image mirroring system 100 of the disclosure may directly change the mirroring layout of the mirrored second image in the second display device, thereby freely controlling the mirroring layout.

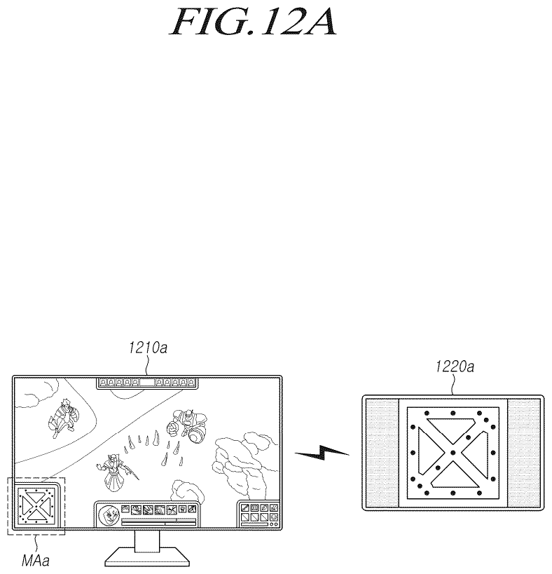

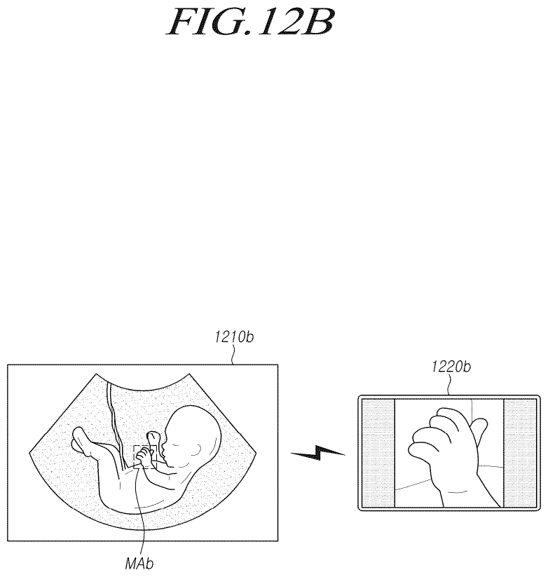

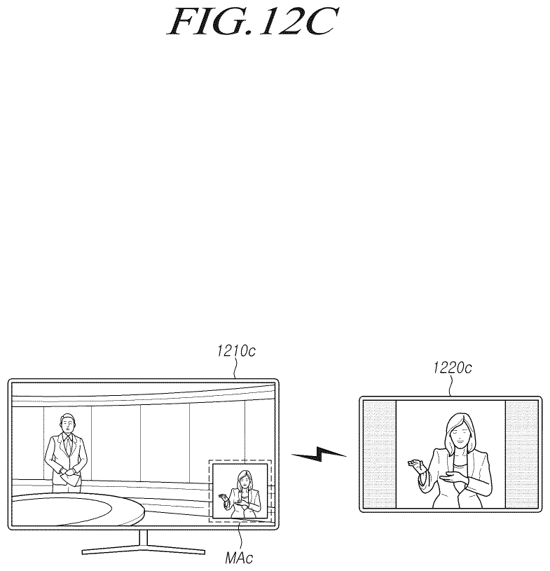

FIGS. 12A, 12B and 12C are diagrams illustrating an application of an image mirroring system 100 according to various embodiments.

Referring to FIGS. 12A, 12B and 12C, the image mirroring system 100 according to various embodiments of the disclosure may perform an image mirroring operation based on various image data.

For example, as illustrated in FIG. 12A, the image mirroring system 100 may perform an image mirroring operation based on image data for a game. In such case, the first display device 1210a may display the entire screen for executing the game. The second display device 1220a may enlarge and display a certain area (e.g., a mini-map) of the game screen.

For example, as illustrated in FIG. 12B, the image mirroring system 100 may perform an image mirroring operation based on image data of medical data (e.g., fetal ultrasound image). In such case, the first display device 1210b may display a full screen of medical data (e.g., the whole body of the fetus). Further, the second display device 1220b may enlarge and display a partial screen of the medical data (e.g., fetal hand).

For example, as illustrated in FIG. 12C, the image mirroring system 100 may perform an image mirroring operation based on image data for sign language broadcasting. In such case, the first display device 1210c may display the entire screen of the broadcast. Further, the second display device 1220c may enlarge and display a partial sign language screen area.

The application of the image mirroring system 100 according to an embodiment of the disclosure is not limited to the examples of FIGS. 12A, 12B and/or 12C.

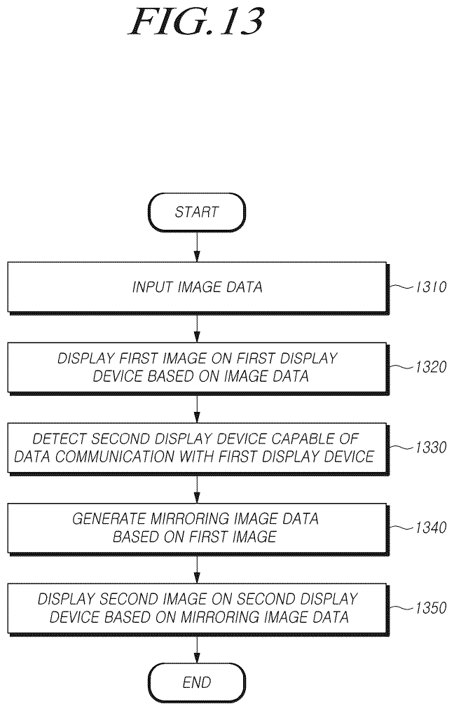

FIG. 13 is a flowchart illustrating example operations of an image mirroring method according to various embodiments.

Referring to FIG. 13, the image mirroring method may include an operation 1310 of receiving image data, an operation 1320 of displaying a first image on a first display device based on the image data, an operation 1330 of detecting a second display device capable of data communication with the first display device, an operation 1340 of generating mirroring image data based on the first image, and an operation 1350 of displaying a second image on the second display device based on the mirroring image data.

According to an example, in operation 1340, the image mirroring method may determine a mirroring area in the first image, generate mirroring image data based on the mirroring area, and output the mirroring image data to the second display device.

For example, the image mirroring method of the disclosure may extract a partial area in the first image of the first display device and determine a mirroring area among the partial areas, thereby selectively providing the mirroring image to the second display device.

According to an example, in operation 1350, the image mirroring method may set a mirroring layout based on the mirroring image data and display device specification, generate second image data based on the mirroring layout, and display the second image on the second display device based on the second image data.

For example, the image mirroring method of the disclosure may directly change the mirroring layout of the mirrored second image on the second display device, thereby freely controlling the mirroring layout.

Therefore, the image mirroring method for the disclosure may increase the usability and utilization of image mirroring technology.

The display device 200 according to various embodiments of the disclosure may be one of various types of electronic devices. The display device 200 may include, for example, a display device, a portable communication device (e.g., a smart phone), a computer device, a portable multimedia device, a portable medical device, a camera, a wearable device, a home appliance, or the like. According to an embodiment of the disclosure, the display device 200 are not limited to those described above.

It should be appreciated that various embodiments of the present disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, or any combination thereof, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the electronic device 200 described herein may be implemented as a hardware component, a software component, and/or a combination thereof. The program may be executed by any system capable of executing computer-readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A display device, comprising:
memory storing at least one instruction;
a display; and
at least one processor, comprising processing circuitry, electrically connected to the memory and individually and/or collectively configured to execute the at least one instruction, and to cause the display device to:
detect at least one external display device capable of data communication;
determine a mirroring area in a first image displayed via the display;
generate mirroring image data based on the mirroring area; and
output at least one of the mirroring image data to the external display device.

2. The display device of claim 1, wherein based on detecting the external display device, at least one processor, individually and/or collectively, is configured to cause the display device to receive from the external display device a display device specification including at least one of a device type, resolution, whether multi-view is supported, a display mode, and a current display image.

3. The display device of claim 1, wherein based on determining the mirroring area, at least one processor, individually and/or collectively, is configured to cause the display device to:
extract at least one partial area formed independently from a surrounding image in the first image; and
determine the partial area as at least one mirroring area, based on any one of an automatic setting mode and a user setting mode.

4. The display device of claim 3, wherein in the automatic setting mode, at least one processor, individually and/or collectively, is configured to cause the display device to:
determine the partial area displayable on the external display device among at least one partial area, based on the display device specification; and
determine the partial area having a highest specification suitability with the display device specification among the at least one partial area as at least one mirroring area.

5. The display device of claim 3, wherein in the user setting mode, at least one processor, individually and/or collectively, is configured to cause the display device to:
provide a selection option for at least one partial area by emphasizing and displaying an edge of the at least one partial area; and
determine at least one mirroring area from among the at least one partial area, based on the selection of the selection option.

6. The display device of claim 1, wherein in an auto tracing mode, at least one processor, individually and/or collectively, is configured to cause the display device to:
detect a moving object moving in the first image;
extract a moving object area including the moving object; and
determine the moving object area as at least one mirroring area, based on at least one of an automatic setting mode and a user setting mode.

7. A display device, comprising:
memory storing at least one instruction;
a display; and
at least one processor, comprising processing circuitry, electrically connected to the memory and individually and/or collectively configured to execute the at least one instruction, and to cause the display device to:
receive mirroring image data from at least one external display device;
set a mirroring layout based on the mirroring image data and a display device specification;
generate second image data based on the mirroring layout; and
display via the display a second image based on the second image data.

8. The display device of claim 7, wherein based on setting the mirroring layout, at least one processor, individually and/or collectively, is configured to cause the display device to:
set a screen layout including at least one of a display mode of the second image and a second image count;
set a frame layout including at least one of a size of the second image, a position of the second image, and a frame shape of the second image; or
set a content layout including at least one of a zoom-in of the second image, a zoom-out of the second image, and a center shift of the second image.

9. The display device of claim 8, wherein at least one processor, individually and/or collectively, is configured to cause the display device to automatically set at least one of the screen layout, the frame layout, and the content layout, based on the display device specification.

10. The display device of claim 8, wherein at least one processor, individually and/or collectively, is configured to cause the display device to set at least one of the screen layout, the frame layout, and the content layout, based on an input.

11. An image mirroring method, comprising:
receiving image data;
displaying a first image based on the image data;
detecting at least one external display device capable of data communication;
determining a mirroring area in the first image;
generating mirroring image data based on the mirroring area; and
outputting the mirroring image data to the at least one external display device.

12. The image mirroring method of claim 11, wherein the detecting the external display device includes receiving from the external display device a display device specification including at least one of a device type, resolution, whether multi-view is supported, a display mode, and a current display image.

13. The image mirroring method of claim 11, wherein the determining the mirroring area includes:
extracting at least one partial area formed independently from a surrounding image in the first image; and
determining the partial area as at least one mirroring area based on any one of an automatic setting mode and a user setting mode.

14. The image mirroring method of claim 13, wherein in the automatic setting mode, the determining the mirroring area comprises:
determining the partial area displayable on the external display device among at least one partial area based on the display device specification; and
determining the partial area having a highest specification suitability with the display device specification among the at least one partial area as at least one mirroring area.

15. The image mirroring method of claim 13, wherein in the user setting mode, the determining the mirroring area comprises:
providing a selection option for at least one partial area by emphasizing and displaying an edge of the at least one partial area; and
determining at least one mirroring area from among the at least one partial area, based on the selection of the selection option.

16. The image mirroring method of claim 11, wherein in an auto tracing mode, the determining the mirroring area may comprises:
detecting a moving object moving in the first image,
extracting a moving object area including the moving object, and
determining the moving object area as at least one mirroring area based on at least one of an automatic setting mode and a user setting mode.
